(19) United States
(12) Patent Application Publication
(10) Pub. No.: US 2016/0121493 A1
(43) Pub. Date: May 5, 2016

(54) FOLDING KNIFE WITH SAFETY MECHANISM

(71) Applicant: GB II Corporation dba Columbia River Knife & Tool Company, Tualatin, OR (US)

(72) Inventor: Flavio Yuji Ikoma, Presidente Prudente (BR)

(73) Assignee: GB II Corporation dba Columbia River Knife & Tool Company, Tualatin, OR (US)

(21) Appl. No.: 14/929,024

(22) Filed: Oct. 30, 2015

Related U.S. Application Data
(60) Provisional application No. 62/073,851, filed on Oct. 31, 2014.

(51) Int. Cl. B26B 1/04

(52) U.S. Cl. CPC B26B 1/048; B26B 1/042

(57) ABSTRACT

Folding knife embodiments are disclosed herein comprising a blade operable to pivot relative to a handle, between an open position and a closed position, a blade-locking mechanism disposed in the handle and being moveable in a first direction between an unlocked position and a locked position to retain the blade in at least one of the open or closed positions. The folding knife may further comprise a safety mechanism mounted on the blade-locking mechanism and being moveable relative thereto in a second direction between a release position and a safety position. Wherein when the safety mechanism is in the safety position, the safety mechanism and the blade-locking mechanism are blocked from moving in the first direction, and wherein when the safety mechanism is in the release position, the safety mechanism and the blade-locking mechanism can be moved in the first direction to move the blade-locking mechanism to the unlocked position.

### CROSS REFERENCE TO RELATED APPLICATION

This application claims the benefit of U.S. Provisional Patent Application No. 62/073,851, filed Oct. 31, 2014, which is incorporated herein by reference.

### FIELD

The present disclosure concerns embodiments of a folding knife having a safety mechanism for preventing inadvertent opening and/or closing of a blade.

### BACKGROUND

Folding knives can include a locking member configured to engage a portion of the blade when the blade is in the open position, thereby preventing the blade from folding closed during normal use. Some folding knives include a safety mechanism to prevent the locking member from disengaging from the blade during use, although such safety mechanisms can be inadvertently disengaged. Accordingly, improvements to folding knives are desirable.

### SUMMARY

In one embodiment of the present disclosure, a folding knife may comprise a handle, a blade pivotably coupled to the handle and operable to pivot between a closed position and an open position, a blade-locking mechanism disposed in the handle and being moveable in a first direction between an unlocked position and a locked position to retain the blade in at least one of the open or closed positions and a safety mechanism slidably mounted on the blade-locking mechanism and being moveable in the first direction and a second direction perpendicular to the first direction. The safety mechanism may be configured to block the blade-locking member from moving from the locked position to the unlocked position when the blade is in one of the open or closed positions.

In some embodiments, the safety mechanism may be movable in the second direction between a release position and a safety position, wherein when the safety mechanism is in the safety position, the safety mechanism and the blade-locking mechanism are blocked from moving in the first direction, and wherein when the safety mechanism is in the release position, the safety mechanism and the blade-locking mechanism can be moved in the first direction to move the blade-locking mechanism to the unlocked position. The folding knife may further comprise a first biasing mechanism configured to resiliently urge the safety mechanism to the safety position. The folding knife may further comprise a second biasing mechanism configured to resiliently urge the blade-locking mechanism to the locked position.

Additionally and/or alternatively, in some embodiments the blade-locking mechanism may comprise a cross-bolt. Additionally and/or alternatively, the first direction may be parallel to a pivot axis of the blade. Additionally and/or alternatively, the handle may comprise a recessed portion and the safety mechanism may be moveable in the first direction and in the second direction within the recessed portion. Additionally and/or alternatively, the safety mechanism may comprise an elongated slot and the blade-locking mechanism may comprise a projection disposed within the elongated slot such that the safety mechanism may be moveable in the second direction relative to the projection. Additionally and/or alternatively, the blade-locking mechanism and the safety mechanism may be configured to be jointly operable by a user's thumb. Additionally and/or alternatively, the safety mechanism may be disposed above a surface of the handle when the blade-locking mechanism is in the locked position and may be disposed below or flush with the surface of the handle when the blade-locking mechanism is in the unlocked position.

In some embodiments of the present disclosure, a method of using a folding knife may comprise moving a safety mechanism with a thumb causing the safety mechanism to move from a safety position to a release position, the safety mechanism being moveably mounted to a blade-locking mechanism disposed in a handle. The method may further comprise moving the blade-locking mechanism with the thumb causing the blade-locking mechanism to move from a locked position to an unlocked position while maintaining pressure on the safety mechanism such that the safety mechanism remains in the release position and pivoting the blade to move from one of an open position to a closed position or the closed position to the open position.

In some embodiments, moving the blade-locking mechanism may comprise pressing the blade-locking mechanism in a first direction towards the handle. Additionally and/or alternatively, moving the safety mechanism may comprise sliding the safety mechanism in a second direction perpendicular to the first direction. Additionally and/or alternatively, the safety mechanism may contact an inner surface of the handle when the safety mechanism is in the safety position so as to block the blade-locking mechanism from being moved to the unlocked position. Additionally and/or alternatively, moving the safety mechanism may further comprise compressing a biasing mechanism of the safety mechanism, the biasing mechanism being configured to bias the safety mechanism toward the safety position.

In some embodiments of the present disclosure, a folding knife may comprise a handle, a blade, the blade having a tang portion that is pivotably coupled to the handle and operable to pivot between a closed position and an open position and a blade-locking mechanism disposed in the handle and being moveable in a first direction between an unlocked position and a locked position to retain the blade in at least one of the open or closed positions. The folding knife may further comprise a safety mechanism mounted on the blade-locking mechanism and being moveable relative thereto in a second direction between a release position and a safety position, wherein when the safety mechanism is in the safety position, the safety mechanism and the blade-locking mechanism are blocked from moving in the first direction, and wherein when the safety mechanism is in the release position, the safety mechanism and the blade-locking mechanism can be moved in the first direction to move the blade-locking mechanism to the unlocked position.

In some embodiments, the folding knife may further comprise a biasing mechanism configured to resiliently urge the safety mechanism to the safety position. Additionally and/or alternatively, the first direction may be parallel to a pivot axis of the blade. Additionally and/or alternatively, the second direction may be perpendicular to the first direction. Additionally and/or alternatively, the blade-locking mechanism may comprise a projection extending from a first end potion of the blade-locking mechanism and the safety mechanism may be slidably mounted on the projection.

### BRIEF DESCRIPTION OF THE DRAWINGS

FIG. 1 is a perspective view of a folding knife showing the blade in a closed position, according to one embodiment.

FIG. 2 is a perspective view of the folding knife of FIG. 1 showing the blade in an open position.

FIG. 3 is another perspective view of the folding knife of FIG. 1 shown with the blade in the closed position.

FIG. 4 is an exploded view of the folding knife of FIG. 1.

FIGS. 5A and 5B are exploded views of a safety mechanism and a cross-bolt of the folding knife of FIG. 1.

FIG. 6A is a side view of the folding knife of FIG. 1 showing the blade in the closed and locked position.

FIG. 6B is an enlarged cross-sectional view of the folding knife taken along line 6B-6B of FIG. 6A, showing the safety mechanism in the safety position and the cross-bolt in the locked position.

FIG. 6C is an enlarged cross-sectional view of the folding knife of FIG. 6A, showing the safety mechanism in the release position and the cross-bolt in the locked position.

FIG. 6D is an enlarged cross-sectional view of the folding knife of FIG. 6A, showing the safety mechanism in the release position and the cross-bolt in the unlocked position.

FIG. 7A is a side view of the folding knife of FIG. 1 showing the blade in the open and locked position.

FIG. 7B is an enlarged cross-sectional view of the folding knife taken along line 7B-7B of FIG. 7A, showing the safety mechanism in the safety position and the cross-bolt in the locked position.

FIG. 7C is an enlarged cross-sectional view of the folding knife of FIG. 7A, showing the safety mechanism in the release position and the cross-bolt in the locked position.

FIG. 7D is an enlarged cross-sectional view of the folding knife of FIG. 7A, showing the safety mechanism in the release position and the cross-bolt in the unlocked position.

FIG. 8 is a side view of the folding knife of FIG. 1 showing the locked position of the cross-bolt relative to the blade when the blade is in the closed position.

FIG. 9 is a side view of the folding knife of FIG. 1 showing the locked position of the cross-bolt relative to the blade when the blade is in the open position.

### DETAILED DESCRIPTION

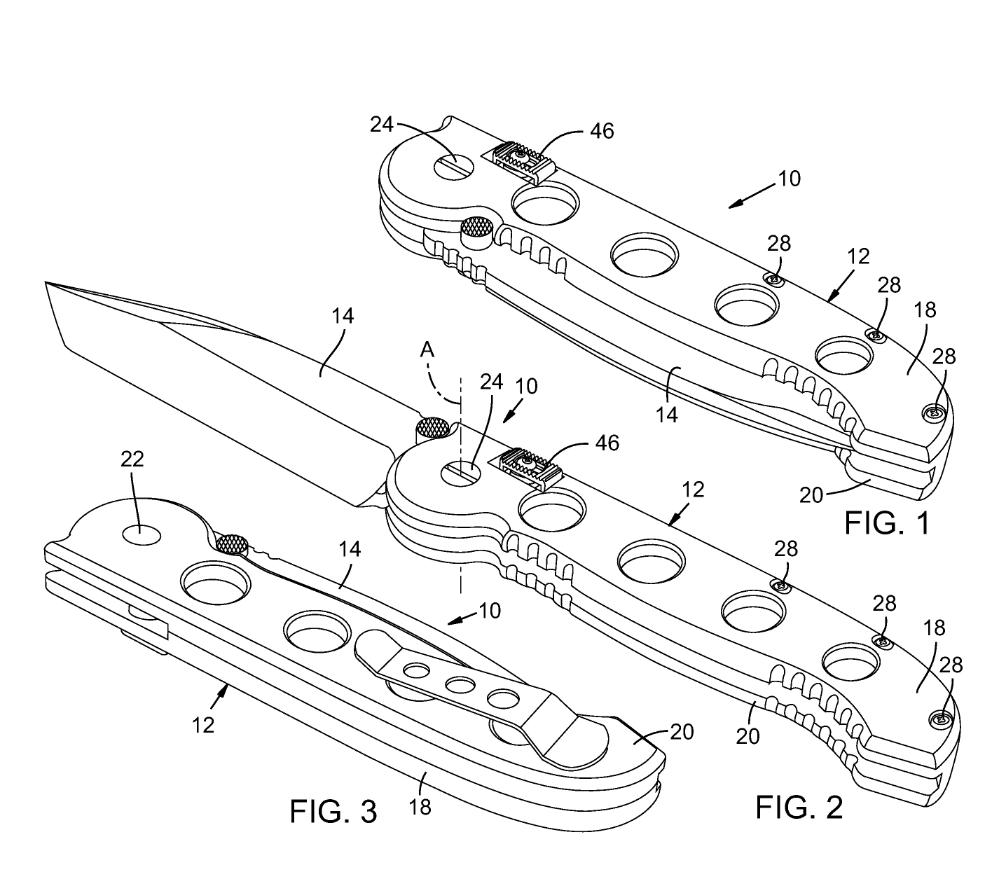

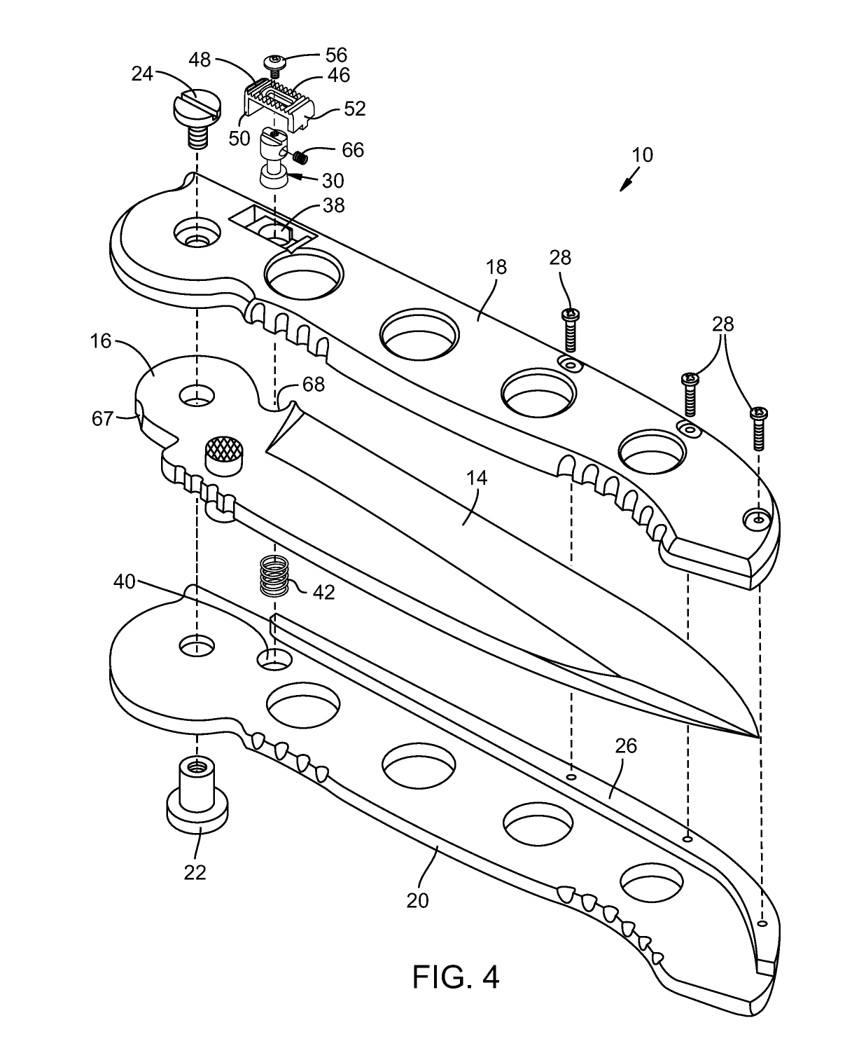

Referring to the figures, there is shown a folding knife 10, according to one embodiment. The knife 10 may comprise a handle 12 and a blade 14 pivotally coupled to the handle at a base or tang portion 16 of the blade 14. The handle 12 of the knife 10 may comprise a first half 18 (first handle or side portion) and a second half 20 (second handle or side portion) with the blade 14 disposed there-between. The blade 14 may be pivotable about a pivot axis A between a closed position and an open position. The closed position may include a folded position as shown in FIG. 1 and/or the open position may include a ready for use position, shown in FIG. 2.

The blade 14 may be connected to the handle 12 by a conventional pivot assembly comprising a pivot pin, or shaft, 22 and a screw 24. The pivot pin 22 may extend through corresponding openings in the second handle portion 20 and the blade tang 16. The screw 24 may extend through an opening in the first handle portion 18 and may be tightened into an internally threaded bore of the pivot pin 22. The handle 12 may further include a spacer or spline 26 disposed between the first and second handle portion 18, 20, respectively, all of which components may be secured to each other with a plurality of screws 28.

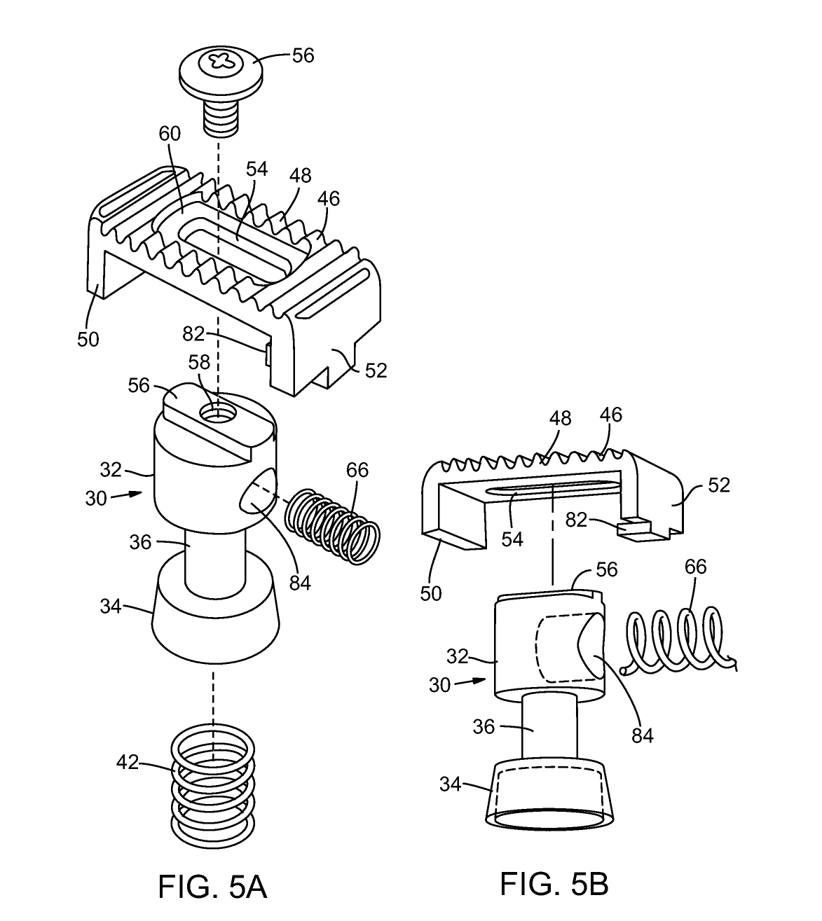

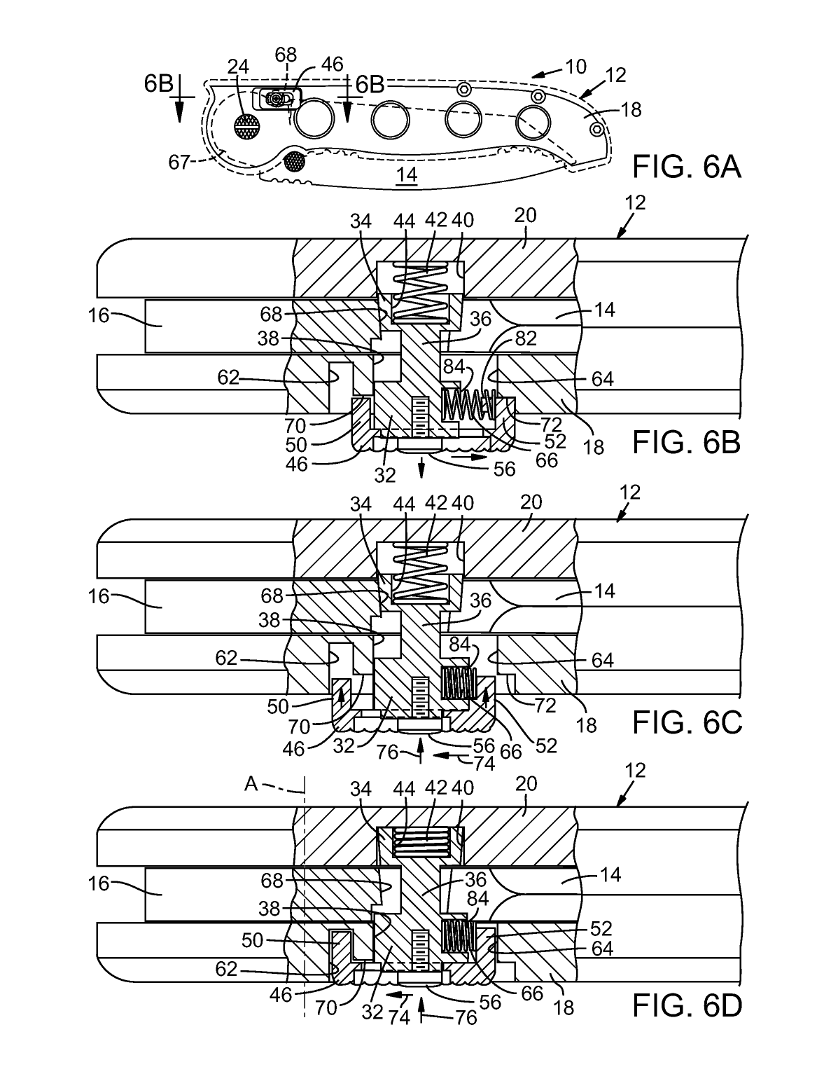

For example, in some embodiments, as best shown in FIGS. 5A-5B, the knife may include a blade-locking or latch mechanism in the form of a cross-bolt 30, which may be configured to lock the blade in the open and/or closed position until activated by a user. The cross-bolt 30 may be referred to as a “button” lock since a user may actuate the cross-bolt 30 by pressing it like a button, as further described below. The cross-bolt 30 may comprise first and second enlarged end portions 32, 34, respectively, and a necked-down intermediate shaft portion 36. As best shown in FIGS. 6B-6D, the cross-bolt 30 may extend laterally (parallel to pivot axis A) through the handle 12 adjacent the tang 16 of the blade 14. The first end portion 32 may be moveable laterally (side-to-side) within an opening 38 in the first side portion 18 of the handle and the second end portion 34 may be moveable laterally within an opening or recess 40 in the second side portion 20 of the handle.

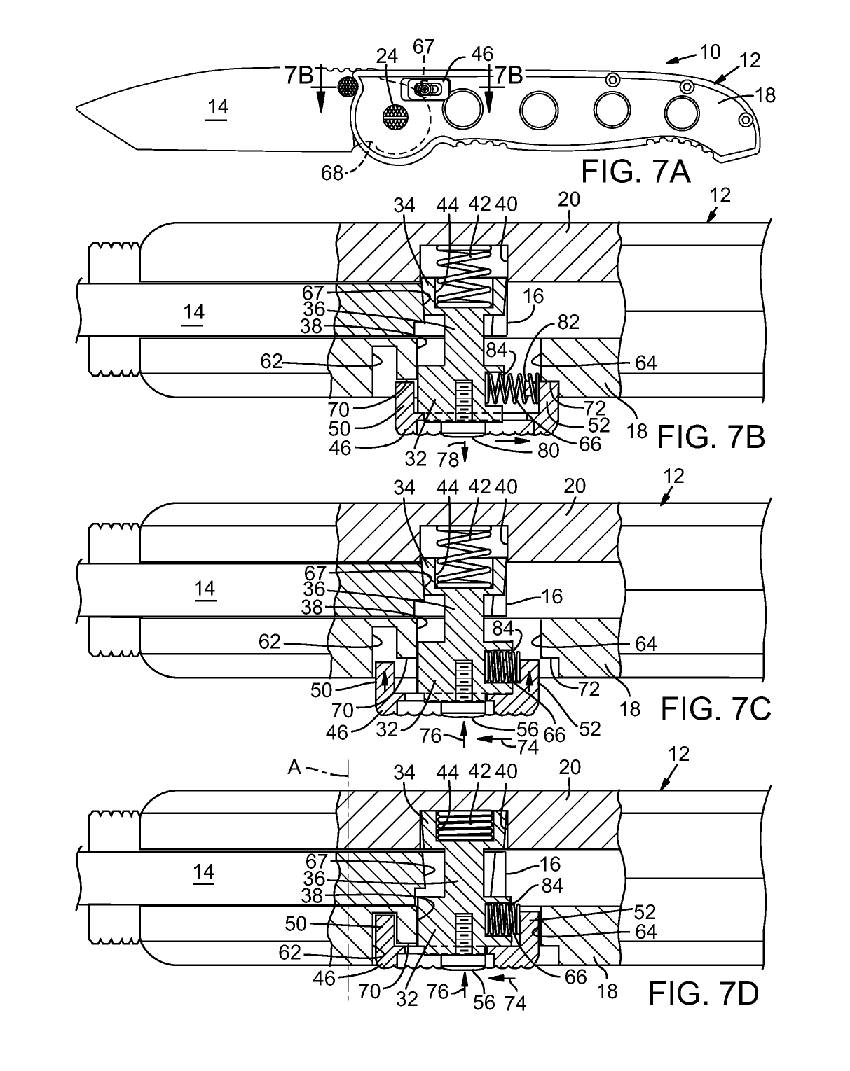

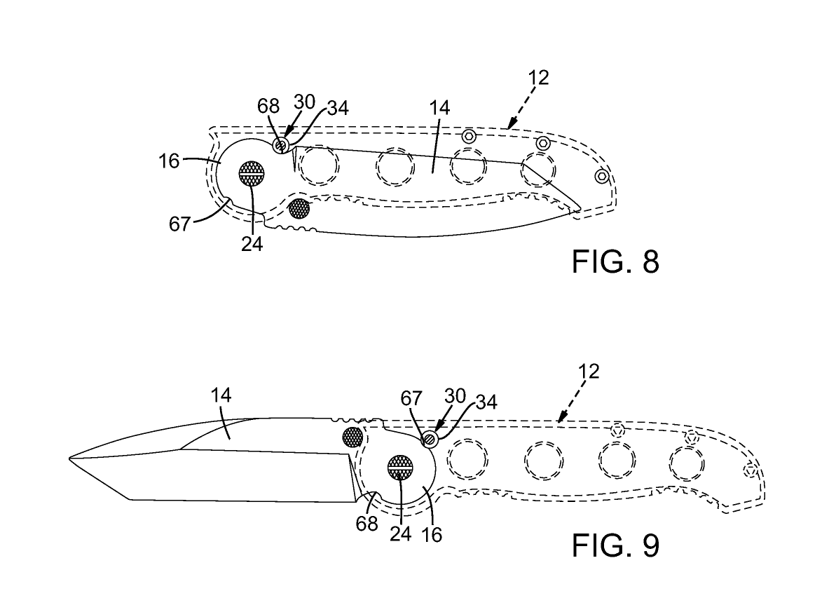

The cross-bolt 30 may be moveable laterally between a locked position (FIG. 6B) to block pivoting movement of the blade 14, and an unlocked position (FIG. 6D) to permit pivoting movement of the blade 14. When the blade 14 is in the closed position and the cross-bolt 30 is in the locked position, the second end portion 34 of the cross-bolt 30 may contact a notched surface 68 formed in the tang 16 (as best shown in FIGS. 6B and 8), thereby blocking pivoting movement of the blade away from the closed position. When the blade is in the open position and the cross-bolt is in the locked position, the second end portion 34 of the cross-bolt may contact another notched surface 67 formed in the tang 16 (FIGS. 7B and 9), thereby blocking pivoting movement of the blade 14 away from the open position. Pushing the cross-bolt 30 laterally toward the second side portion 20 of the handle may remove the second end portion 34 from contacting notched surfaces 67, 68 and may allow the blade to be pivoted open or closed.

The cross-bolt 30 may be biased toward the locked position by a biasing element, such as a spring 42. The spring 42 may be partially disposed in a laterally facing recess 44 formed in the second end portion 34 of the cross-bolt. One end of the spring 42 may bear against an adjacent surface within the recess 44 while the opposite end of the spring 42 may bear against an adjacent surface of the recess 40. In this manner, the spring 42 may bias the cross-bolt 30 toward the first side portion 18 of the handle 12 and/or to the locked position.

Some embodiments of the knife 10 may include a safety mechanism 46 to retain the knife 10 in a desired position, namely one of the closed or open positions. As described above, the cross-bolt 30 may be actuated, for example by pressing it like a button, such that the second end portion 34 may be removed from contacting notched surfaces 67, 68, allowing the blade to be pivoted open or closed. The safety mechanism 46 may provide an additional step for disengagement of the cross-bolt 30 from the contacting the tang 16 and/or notched surfaces 67, 68. The likelihood of inadvertent deactivation of the cross-bolt 30 may be reduced, at least in part because of the at least one additional step required by the safety mechanism 46.

Referring again to FIGS. 5A-5B, the knife 10 may further include the safety mechanism 46, which may be mounted on or coupled to the first end portion 32 of the cross-bolt 30. The safety mechanism may be configured to block movement of the cross-bolt 30 to the unlocked position. The safety mechanism 46 may include a user-engageable base 48 and first and second legs 50, 52, respectively, extending laterally from opposite ends of the base 48. The base 48 may be formed with an elongated slot or opening 54. The slot 54 may be configured to receive an oblong projection 56 extending from the first end portion 32 of the cross-bolt 30. The safety mechanism 46 may be connected to the cross-bolt 30. For example, the safety mechanism 46 may be connected to the first end portion 32 of the cross-bolt 30 by a screw 56 that extends into a threaded opening 58 formed in the first end portion 32. The head of screw 56 may be sized such that it does not extend beyond the outer surface of safety mechanism 46. For example, the head of the screw 56 may reside in a recessed portion 60 formed in the base 48 such that the head of the screw 56 does not extend laterally beyond the outer surface of the base 48 (FIG. 6B). The safety mechanism 46 may be moveable relative to the cross-bolt 30 between a first, safety position to block movement of the cross-bolt 30 and a second, release position to permit movement of the cross-bolt 30. For example, the safety mechanism 46 may be slidable longitudinally (in the direction of the length of the handle and/or perpendicular to the pivot axis A) relative to the cross-bolt 30 between a first, safety position (FIG. 6B) to block movement of the cross-bolt 30 and a second, release position (FIG. 6D) to permit movement of the cross-bolt 30, as further explained below.

As best shown in FIG. 6B, the first side portion 18 of the handle 12 may be configured to permit movement of safety mechanism 46. For example the first side portion 18 may be formed with a recessed portion 62 sized and shaped to receive the first leg 50 of the safety mechanism 46 and a further recessed portion 64 sized and shaped to receive the second leg 52 of the safety mechanism 46 when the safety mechanism is moved to the release position. As shown, the recessed portion 64 may be part of the larger opening 38 that receives the first end portion 32 of the cross-bolt 30.

The safety mechanism 46 may be biased to the safety position and/or blocking movement of cross-bolt 30. A biasing element, such as a spring 66, may be configured to the bias the safety mechanism 46 to the safety position (FIG. 6B). The spring 66 may be disposed inside of the safety mechanism such that one end portion of the spring 66 extends co-axially over a lip 82 connected to the leg 52 and the opposite end portion of the spring 66 extends into an opening 84 in the first end portion 32 of the cross-bolt 30. In this manner, one end of the spring 66 may bear against an adjacent surface of the second leg 52 and the opposite end of the spring may bear against an adjacent surface within the opening 84 of the first end portion 32 of the cross-bolt 30.

Referring to FIGS. 6A-6D, operation of the safety mechanism 46 and the cross-bolt 30 to open the blade will now be described. In the closed and locked position (FIG. 6B), the second end portion 34 of the cross-bolt 30 may contact and/or may be in close proximity to the notched surface 68 of the blade tang 16 such that the cross-bolt blocks movement of the blade 14 from the closed position to the open position. The safety mechanism 46 may be resiliently retained in the safety position by the spring 66 such that the legs 50, 52 of the safety mechanism may be aligned with and/or in close proximity to (and/or in contact with) raised surfaces 70, 72, respectively, formed in the first side portion 18 of the handle 12. In this position, the legs 50, 52 may contact the raised surfaces 70, 72, thereby blocking lateral movement of the cross-bolt 30 away from the locked position.

The safety mechanism 46 may be moveable from the safety position to the release position. While the safety mechanism 46 is in the release position, the cross-bolt 30 may be moveable from the locked position to the unlocked position. For example, the safety mechanism 46 can be moved from the safety position (shown in FIG. 6B) to the release position (shown in FIG. 6C) by applying sufficient manual pressure to the base 48 to overcome the bias of the spring 66 so as to slide the safety mechanism 46 in the direction of arrow 74 until the legs 50, 52 are moved away from the raised surfaces 70, 72 and are aligned with the recessed portions 62, 64. While maintaining manual pressure on the safety mechanism (against the bias of the spring 66), the cross-bolt 30 can be depressed inwardly in the direction of arrow 76 against the bias of spring 42 so as to move the cross-bolt 30 to the unlocked position.

As shown in FIG. 6D, the recessed portions 62, 64 may be deep enough to permit sufficient lateral movement of the legs 50, 52 and the cross-bolt 30 until the first end portion 32 may be received in the opening 38 in the first side portion 18 of the handle 12 and the second end portion 34 is fully received in the opening 40 in the second side portion 20 of the handle 12 and no longer in the path of travel of the blade 14. In this position, the blade 14 can be pivoted from the closed position to the open position. As can be appreciated, the safety mechanism 46 and the cross-bolt 30 can be activated using a single digit of the hand (e.g., the thumb) by first sliding the safety mechanism 46 in a first direction to the release position (FIG. 6C) and then pushing the safety mechanism 46 and the cross-bolt 30 in a second direction to move the cross-bolt 30 to the unlocked position (FIG. 6D).

In particular embodiments, the knife 10 can be a so-called automatic knife having a spring or another biasing mechanism (e.g., a torsion spring) that forces the blade 14 to the move from the closed position to the fully open position (FIG. 2) when the cross-bolt 30 is moved to the unlocked position shown in FIG. 6D. Details of a spring that can be implemented in the knife 10 to provide the opening force to the blade are provided in U.S. Pat. No. 8,375,589, which is incorporated herein by reference.

When the blade 14 has reached the fully open position (FIG. 7A), manual pressure can be released from the safety mechanism 46, allowing the spring 42 to move the cross-bolt 30 in the direction of arrow 78 back to the locked position and allowing the spring 66 to move the safety mechanism 46 in the direction of arrow 80 to the safety position (FIG. 7B). In this position, the second end portion 34 of the cross-bolt 30 may block the path of travel of the blade 14 and the legs 50, 52 may again be aligned with the raised surface portions 70, 72 in the first side portion 18 of the handle, thereby blocking inward lateral movement of the safety mechanism 46 and the cross-bolt 30. To permit closing of the blade, manual pressure can be applied to the safety mechanism 46 to first move the safety mechanism in the direction of arrow 74 to the release position (FIG. 7C), and then to move the cross-bolt 30 in the direction of arrow 76 to the unlocked position (FIG. 7D). In this position, the second end portion 34 may be fully received in the opening 40 and/or may no longer blocks the path of travel of the blade.

In other embodiments, the knife 10 can be a so-called assisted-opening knife having a spring or other biasing mechanism that a provides biasing force that retains the blade in the closed position and then provides an opening force to the blade to assist in opening the blade after the blade has been manually pivoted from the closed position to a partially open position. Spring configurations for assisted-opening knives are disclosed in U.S. Pat. No. 6,834,432 and U.S. Pat. No. 6,145,202, which are incorporated herein by reference. Desirably, although not necessarily, when the knife 10 is an assisted-opening knife, the blade-latching mechanism (e.g., a cross-bolt) is configured to engage and lock the blade in the open position but not the closed position. Thus, in such cases, the user need not move the safety mechanism to the release position in order to open the blade. Similarly, when the knife 10 comprises a manually-opened knife (a knife without any spring or other biasing element that exerts an opening force on the blade), the blade-latching mechanism (e.g., a cross-bolt) can be configured to engage and lock the blade in the open position but not the closed position such that the user need not move the safety mechanism to the release position in order to open the blade. In other embodiments of assisted-opening knives or manually-opened knives, the blade-latching mechanism (e.g., a cross-bolt) can be configured to engage and lock the blade in the open position and the closed position such that the user moves the safety mechanism to the release position in order to open the blade, as described in detail above.

The safety mechanism 46 can also be implemented in folding knives having other types of blade-latching mechanisms, and in particular any type of blade-latching mechanism that is moved from an unlocked position to a locked position by depressing the blade-latching mechanism to move it in the direction of its longitudinal axis. For example, co-pending U.S. application Ser. No. 14/855,179, filed Sep. 15, 2015, which is incorporated herein by reference, discloses a folding knife having a blade-locking mechanism that is moved from a locked position to an unlocked position by pushing the blade-locking mechanism laterally into the handle (perpendicular to the length of knife and parallel to the pivot pin) similar to the cross-bolt 30. Such a knife can include the safety mechanism 46 to prevent inadvertent movement of the blade-locking mechanism.

In alternative embodiments, the safety mechanism 46 can be implemented in a folding knife having a liner lock or frame lock. As known in the art, a liner lock or frame lock comprises a laterally moveable leaf spring formed in a liner or frame of the handle that is biased to move to a locked positioned behind the blade tang, typically when the blade is in the open position. The safety mechanism can be, for example, mounted on the leaf spring for movement between a safety position that blocks lateral movement of the leaf spring and a release position that allows lateral movement of the leaf spring away from blade tang to permit pivoting movement of the blade.

For purposes of this description, certain aspects, advantages, and novel features of the embodiments of this disclosure are described herein. The disclosed methods, devices, and systems should not be construed as limiting in any way. Instead, the present disclosure is directed toward all novel and nonobvious features and aspects of the various disclosed embodiments, alone and in various combinations and sub-combinations with one another. The methods, devices, and systems are not limited to any specific aspect or feature or combination thereof, nor do the disclosed embodiments require that any one or more specific advantages be present or problems be solved.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods. As used herein, the terms “a”, “an”, and “at least one” encompass one or more of the specified element. That is, if two of a particular element are present, one of these elements is also present and thus “an” element is present. The terms “a plurality of” and “plural” mean two or more of the specified element.

As used herein, the term “and/or” used between the last two of a list of elements means any one or more of the listed elements. For example, the phrase “A, B, and/or C” means “A”, “B”, “C”, “A and B”, “A and C”, “B and C”, or “A, B, and C.”

As used herein, the term “coupled” generally means physically coupled or linked and does not exclude the presence of intermediate elements between the coupled items absent specific contrary language.

In the description, certain terms may be used such as “up,” “down,”, “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A folding knife comprising:
a handle;
a blade pivotably coupled to the handle and operable to pivot between a closed position and an open position;
a blade-locking mechanism disposed in the handle and being moveable in a first direction between an unlocked position and a locked position to retain the blade in at least one of the open or closed positions; and
a safety mechanism slidably mounted on the blade-locking mechanism and being moveable in the first direction and a second direction perpendicular to the first direction;
wherein the safety mechanism is configured to block the blade-locking member from moving from the locked position to the unlocked position when the blade is in one of the open or closed positions.

2. The folding knife of claim 1, wherein the safety mechanism is movable in the second direction between a release position and a safety position, wherein when the safety mechanism is in the safety position, the safety mechanism and the blade-locking mechanism are blocked from moving in the first direction, and wherein when the safety mechanism is in the release position, the safety mechanism and the blade-locking mechanism can be moved in the first direction to move the blade-locking mechanism to the unlocked position.

3. The folding knife of claim 2, further comprising a first biasing mechanism configured to resiliently urge the safety mechanism to the safety position.

4. The folding knife of claim 3, further comprising a second biasing mechanism configured to resiliently urge the blade-locking mechanism to the locked position.

5. The folding knife of claim 1, wherein the blade-locking mechanism comprises a cross-bolt.

6. The folding knife of claim 1, wherein the first direction is parallel to a pivot axis of the blade.

7. The folding knife of claim 1, wherein the handle comprises a recessed portion and the safety mechanism is moveable in the first direction and in the second direction within the recessed portion.

8. The folding knife of claim 1, wherein the safety mechanism comprises an elongated slot and the blade-locking mechanism comprises a projection disposed within the elongated slot such that the safety mechanism is moveable in the second direction relative to the projection.

9. The folding knife of claim 1, wherein the blade-locking mechanism and the safety mechanism are configured to be jointly operable by a user's thumb.

10. The folding knife of claim 1, wherein the safety mechanism is disposed above a surface of the handle when the blade-locking mechanism is in the locked position and is disposed below or flush with the surface of the handle when the blade-locking mechanism is in the unlocked position.

11. A method of using a folding knife, comprising:
moving a safety mechanism with a thumb causing the safety mechanism to move from a safety position to a release position, the safety mechanism being moveably mounted to a blade-locking mechanism disposed in a handle;
moving the blade-locking mechanism with the thumb causing the blade-locking mechanism to move from a locked position to an unlocked position while maintaining pressure on the safety mechanism such that the safety mechanism remains in the release position; and
pivoting the blade to move from one of an open position to a closed position or the closed position to the open position.

12. The method of claim 11, wherein moving the blade-locking mechanism comprises pressing the blade-locking mechanism in a first direction towards the handle.

13. The method of claim 12, wherein moving the safety mechanism comprises sliding the safety mechanism in a second direction perpendicular to the first direction.

14. The method of claim 11, wherein the safety mechanism contacts an inner surface of the handle when the safety mechanism is in the safety position so as to block the blade-locking mechanism from being moved to the unlocked position.

15. The method of claim 11, wherein moving the safety mechanism further comprises compressing a biasing mechanism of the safety mechanism, the biasing mechanism being configured to bias the safety mechanism toward the safety position.

16. A folding knife comprising:
a handle;
a blade, the blade having a tang portion that is pivotably coupled to the handle and operable to pivot between a closed position and an open position;
a blade-locking mechanism disposed in the handle and being moveable in a first direction between an unlocked position and a locked position to retain the blade in at least one of the open or closed positions; and
a safety mechanism mounted on the blade-locking mechanism and being moveable relative thereto in a second direction between a release position and a safety position, wherein when the safety mechanism is in the safety position, the safety mechanism and the blade-locking mechanism are blocked from moving in the first direction, and wherein when the safety mechanism is in the release position, the safety mechanism and the blade-locking mechanism can be moved in the first direction to move the blade-locking mechanism to the unlocked position.

17. The folding knife of claim 16, further comprising a biasing mechanism configured to resiliently urge the safety mechanism to the safety position.

18. The folding knife of claim 16, wherein the first direction is parallel to a pivot axis of the blade.

19. The folding knife of claim 18, wherein the second direction is perpendicular to the first direction.

20. The folding knife of claim 16, wherein the blade-locking mechanism comprises a projection extending from a first end potion of the blade-locking mechanism and the safety mechanism is slidably mounted on the projection.
